(19) United States
(12) Patent Application Publication
(10) Pub. No.: US 2005/0274738 A1
(43) Pub. Date: Dec. 15, 2005

(54) System and method to heat and dispense water

(76) Inventors: Steven F. Tomsic, Phoenix, AZ (US); Justin R. Lydon, Queen Creek, AZ (US)

Correspondence Address: Jordan M. Meschkow;MESCHKOW & GRESHAM, P.L.C., Suite 409, 5727 North Seventh Street, Phoenix, AZ, 85014-5818, US

(21) Appl. No.: 10/855,583

(22) Filed: May 26, 2004

(51) Int. Cl. B67D 5/56

(52) U.S. Cl. 222/129.4

(57) ABSTRACT

A system (200) and method to heat and dispense water (236,240) at one of a lower pressure and a higher pressure. Low-pressure unheated water (238) is heated to become low-pressure heated water (236), which then passes through a normally open solenoid valve (210) to arrive at a spout (202). If a pressure-control device (222) is open or not affixed to the spout (202), then the spout (202) dispenses the low-pressure heated water (236). If the pressure-control device (222) is closed or affixed to the spout (202), then the low-pressure heated water (236) is inhibited from passing through the spout (202), and the pressure at a pressure sensor (218) is substantially the lower pressure. In this case, the normally open solenoid valve (210) is closed and a normally closed solenoid valve (212) is opened. The low-pressure heated water (236) then passes through the now-open normally closed solenoid valve (212) and to a pump (214), where it becomes a high-pressure heated water (240), which is then dispensed by the spout (202).

### TECHNICAL FIELD OF THE INVENTION

The present invention relates to the field of water dispensing systems. More specifically, the present invention relates to the field of systems to heat and dispense water for the production of beverages or for other purposes.

### BACKGROUND OF THE INVENTION

There are many systems to heat and dispense water with which to make an “instant” or steeped beverage. Many of these systems are excessively complex and/or expensive. Such complex and/or expensive systems place themselves beyond the purview of general household applications. For this reason, there is a continuing need for a simple and inexpensive system to heat and dispense water.

Additionally, in the average household, counter space is at a premium. For this reason, there is also a continuing need for a system to heat and dispense water that occupies little or no counter space.

FIG. 1 depicts a schematic view of a prior-art system 100 to heat and dispense water, and FIG. 2 depicts a schematic view of system 100 dispensing heated water 102. The following discussion refers to prior-art FIGS. 1 and 2.

System 100 is simple in that it consists primarily of a water heater 104 and a faucet 106, with interconnecting water lines. Typically, a supply line 108 connects an external water supply 110 (e.g., a domestic water system) to a faucet valve 112 within faucet 106, an input line 114 connects faucet valve 112 to water heater 104, and an output line 120 connects water heater 104 to a spout 116 of faucet 106.

Faucet valve 112 has a closed state and an open state. When faucet valve 112 is in its closed state (FIG. 1), system 100 is inhibited from dispensing heated water 102.

When faucet valve 112 is moved to its open state (FIG. 2), the pressure within external water supply 110 causes unheated water 118 (i.e., water not yet heated by water heater 104) to flow from external water supply 110, through supply line 108, through faucet valve 112, through input line 114, and into water heater 104. Water heater 104 heats unheated water 118 to produce heated water 102. Desirably, heated water 102 is near-boiling water, i.e., water hotter than 176° F. (80° C.).

Heated water 102 flows from water heater 104 through an output line 120 and into spout 116. Spout 116 (i.e., system 100) then dispenses heated water 102 into a beverage receptacle 122 (e.g., a cup), where heated water 102 may mix with a beverage essence (not shown), e.g., instant coffee or cocoa powder, to produce the desired beverage.

Alternatively, heated water 102 may be dispensed into an empty beverage receptacle 122, with the beverage essence, e.g., a tea bag, added later.

In a typical installation (not shown), faucet 106 is mounted to the edge of a sink (or to a countertop proximate a sink) so that spout 116 overhangs a basin of the sink. Supply line 108, input line 114, water heater 104, output line 120, and all connections (including an electrical connection for water heater 104) are below the countertop (typically under the sink), and are therefore out of the way and out of sight. In this installation only faucet 106 occupies counter space.

By mounting faucet 106 so that spout 116 overhangs the basin, beverage receptacle 122 may easily be placed or held within the basin for filling. Additionally, any spillage will be directed into the basin, which may be easily cleaned.

Water heater 104 may be of the reservoir type, in which a quantity of heated water 102 (typically between two and six quarts) is available for immediate use. Alternatively, water heater 104 may of the flash heater type, which lacks a reservoir. In a flash heater, unheated water 118 is heated to become heated water 104 on demand. In either case, the flow of unheated water 118 into water heater 104 via input line 114 causes heated water 102 to exit water heater 104 via output line 120. Since the only force behind the flow of water in system 100 is the inherent pressure of external water supply 110, system 100 dispenses heated water 102 from spout 116 at substantially that pressure.

System 100 serves well to heat and dispense heated water 102 for beverages such as instant coffee, instant cocoa, instant soup, bouillon, tea, and the like. These “instant” and/or steeped beverages are made by mixing the beverage essence with or steeping the beverage essence in heated water 102.

However, system 100 is incapable of producing beverages that must be made under pressure, such as espresso, cappuccino, and other “pressed” beverages. There is a need, therefore, for a system to heat and dispense heated water at a pressure sufficient for the production of pressed beverages. Such a system should be simple in structure, low in cost, and utilize a minimum of counter space. Desirably, such a system should also be capable of dispensing heated water at a lower pressure for the production of instant and/or steeped beverages.

### SUMMARY OF THE INVENTION

Accordingly, it is an advantage of the present invention that a system and method to heat and dispense water is provided.

It is another advantage of the present invention that a system to heat and dispense water is provided that dispenses heated water at each of a lower pressure and a higher pressure on demand.

It is another advantage of the present invention that a system to heat and dispense water is provided that dispenses heated water at a pressure sufficient for the production of pressed beverages, and also dispenses heated water at a lower pressure for the production of instant and steeped beverages.

It is another advantage of the present invention that a system to heat and dispense water is provided that is simple in structure and low in cost.

It is another advantage of the present invention that a system to heat and dispense water is provided that utilizes a minimum of counter space.

The above and other advantages of the present invention are carried out in one form by a system to heat and dispense water. A water heater receives water at a first temperature and a first pressure, and supplies the water at a second temperature and the first pressure, wherein the second temperature is higher than the first temperature. A pump couples to the water heater, receives the water at the second temperature and the first pressure, and supplies the water at the second temperature and the second pressure, wherein the second pressure is greater than the first pressure. A faucet valve couples to the water heater, and controls a flow of the water into the water heater at the first temperature. A spout couples to the water heater and the pump, and dispenses the water at the second temperature and at one of the first pressure and the second pressure.

The above and other advantages of the present invention are carried out in another form by a method to heat and dispense water at one of a first pressure and a second pressure. The method entails opening a faucet valve to pass water from a water supply into a water heater at a first temperature and the first pressure, heating the water to a second temperature greater than the first temperature, determining if the water is to be dispensed at the first pressure or the second pressure, and dispensing the water from a spout at the second temperature and at one of the first pressure and the second pressure in response to the determining activity.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 depicts a schematic view of a prior-art system to heat and dispense water;

FIG. 2 depicts a schematic view of the prior-art system of FIG. 1 dispensing heated water;

FIG. 3 depicts a schematic view of a dual-pressure system to heat and dispense water in accordance with a preferred embodiment of the present invention;

FIG. 4 depicts a schematic view of a spout for the system of FIG. 3 in accordance with an alternative embodiment of the present invention;

FIG. 5 depicts a schematic view of multiple spouts for the system of FIG. 3 in another alternative embodiment of the present invention;

FIG. 6 depicts a schematic view of the system of FIG. 3 dispensing heated water at a low pressure in accordance with a preferred embodiment of the present invention;

FIG. 7 depicts a schematic view of the system of FIG. 3 determining pressure prior to dispensing heated water at a high pressure in accordance with a preferred embodiment of the present invention; and

FIG. 8 depicts a schematic view of the system of FIG. 3 dispensing heated water at a high pressure in accordance with a preferred embodiment of the present invention.

### DETAILED DESCRIPTION OF THE PREFERRED EMBODIMENTS

Certain terms have specific meanings in the context of this discussion. The term “unheated water” designates water at a first temperature, which temperature is substantially the temperature of the water entering a dual-pressure system to heat and dispense water from an external water source. The term “heated water” designates water at a second temperature, which temperature is greater than the first temperature, and which temperature is substantially the temperature of the water dispensed by the system. The term “low pressure” (adjectively “low-pressure”) designates a first pressure, which pressure is the lower of the two pressures at which the system can dispense water, and which pressure is substantially the pressure of the water within the external water source. The term “high pressure” (adjectively “high-pressure”) designates a second pressure, which pressure is greater than the first pressure, which pressure is the higher of the two pressures at which the system can dispense water, and which pressure is substantially the pressure of the water at an output of a pump within the system.

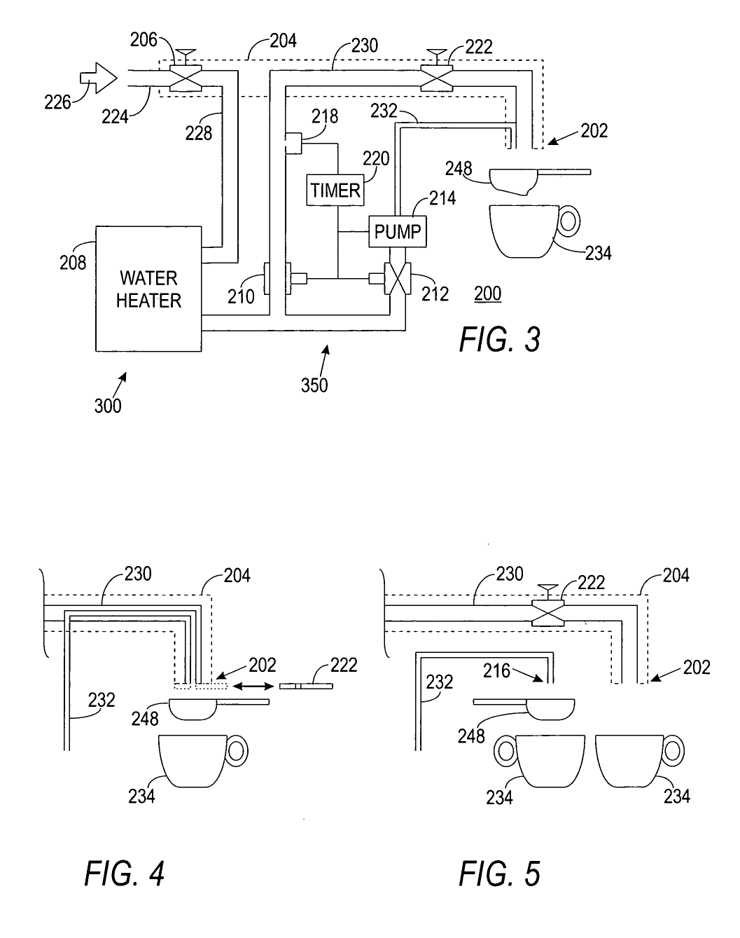

FIG. 3 depicts a schematic view of a dual-pressure system 200 to heat and dispense water in accordance with a preferred embodiment of the present invention. FIGS. 4 and 5 depict schematic views of alternative spouts 202 for system 200 in accordance with a first (FIG. 4) and a second (FIG. 5) alternative embodiment of the present invention. The following discussion refers to FIGS. 3, 4, and 5.

Dual-pressure system 200 to heat and dispense water consists primarily of a faucet 204 made up of a faucet valve 206 and a spout 202, a water heater 208, a normally open (NO) solenoid valve 210, a normally closed (NC) solenoid valve 212, a pump 214, an optional high-pressure spout 216, a pressure sensor 218, a timer 220, and a pressure-control device 222, with interconnecting water lines and electrical circuits.

Within system 200, a supply line 224 couples an external water supply 226 to faucet valve 206. An input line 228 couples faucet valve 206 to water heater 208. A low-pressure output line 230 couples water heater 208 to spout 202 through NO solenoid valve 210 and to pump 214 through NC solenoid valve 212. A high-pressure output line 232 couples pump 214 to spout 202 (FIGS. 3 and 4) or to high-pressure spout 216 (FIG. 5).

Faucet valve 206, NO solenoid valve 210, NC solenoid valve 212, and pressure-control device 222 are all valves of some type and serve to control the flow of water through system 200. In the context of this discussion, a valve has an open state and a closed state. When a valve is in its open state, a flow of water through the valve is permitted. When a valve is in its closed state, a flow of water through the valve is inhibited.

Water heater 208 may be of the reservoir type. In a reservoir heater, a quantity of heated water (typically between two and six quarts) held in a reservoir and is available for immediate use. The reservoir is full at all times during operation. Therefore, an inflow of unheated water under pressure caused an outflow of heated water at substantially the same pressure.

Alternatively, water heater 208 may of the flash heater type, which lacks a reservoir. In a flash heater, a relatively short pipe is thermally coupled to a heating element. An inflow of unheated water triggers activation of the heating element, which then heats the water as it passes through the pipe, resulting in an outflow of heated water.

NO solenoid valve 210 is in its open state when not energized and in its closed state when energized. Conversely, NC solenoid valve 212 is in its closed state when not energized and in its open state when energized. The purpose of NC solenoid valve 212 is to inhibit the flow of water into pump 214 unless NO solenoid valve is in its closed state.

Pump 214 may be unocclusive. If pump 214 is unocclusive, then a flow of water is permitted through pump 214 when pump 214 is unenergized. In this case, NC solenoid valve 212 is required in order to maintain proper operation of pressure sensor 218 (discussed hereinafter).

Alternatively, pump 214 may be occlusive. If pump 214 is occlusive, then water is inhibited from passing through pump 214 when pump 214 is unenergized. As discussed hereinafter, NO solenoid valve 210, NC solenoid valve 212, and pump 214 are energized substantially coincidentally. Therefore, if pump 214 is occlusive, pump 214 serves the same function as NC solenoid valve 212. In this case, NC solenoid valve 212 may be considered to exist as a part of pump 214.

Pressure sensor 218 is coupled to low-pressure output line 230 between NO solenoid valve 210 and spout 202. Pressure sensor 218 is electrically coupled to timer 220, and timer 220 is electrically coupled to NO solenoid valve 210, NC solenoid valve 212, and pump 214.

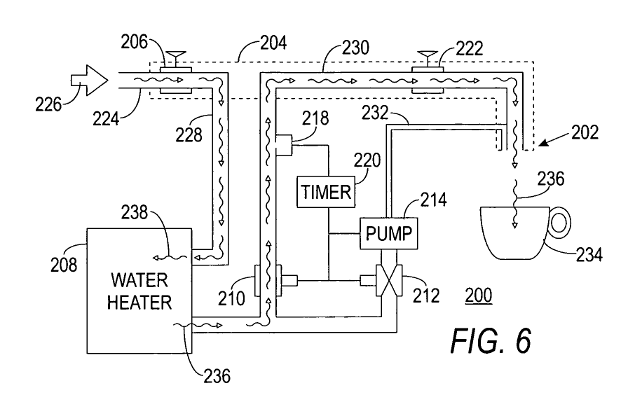

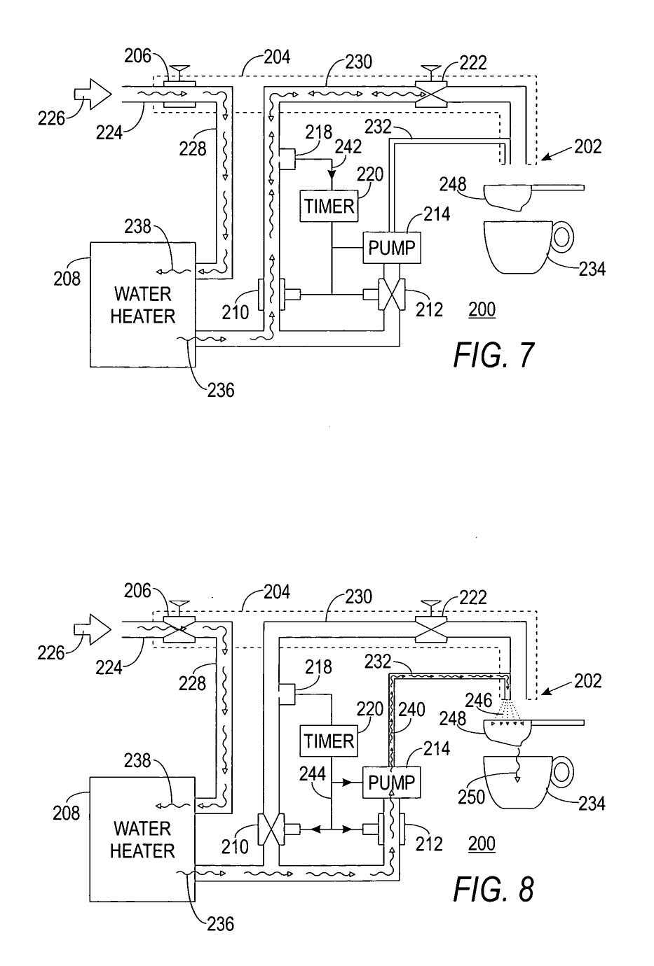

Pressure-control device 222 serves as a valve in low-pressure output line 230 after, or downstream of, pressure sensor 218. Serving as a valve, pressure-control device 222 may be either in its open state or in its closed state. When pressure-control device 222 is in its open state (FIG. 6, discussed hereinafter), low-pressure output line 230 is unoccluded. When pressure-control device 222 is in its closed state (FIGS. 7 and 8, discussed hereinafter), low-pressure output line 230 is occluded.

In one preferred embodiment, pressure-control device 222 may be realized as a valve. Pressure-control device 222 as a valve is depicted in FIGS. 3, 5, 6, 7, and 8 for convenience in understanding the operation of pressure-control device 222.

In the preferred embodiment of FIG. 4, however, pressure-control device 222 is realized as an occluding disk or fitting that removably couples to spout 202. When pressure-control device 222 is not coupled to spout 202, then low-pressure output line 230 is unoccluded. When pressure-control device 222 is coupled to spout 202, then low-pressure output line 230 is occluded. This action of pressure-control device 222 as a disk or fitting (FIG. 4) is analogous to the action of direct-control device 222 as a valve (FIGS. 3, 5, 6, 7, and 8). That is, when pressure-control device 222 is not coupled to spout 202, pressure-control device 222 is in its open state, and when pressure-control device 222 is coupled to spout 202, pressure-control device 222 is in its closed state.

Those skilled in the art will appreciate that the manner in which pressure-control device 222 is realized is not germane to the present invention. Other methods of realizing pressure-control device 222 may be used without departing from the spirit of the present invention.

During operation (discussed hereinafter), low-pressure heated water is dispensed from low-pressure output line 230 and high-pressure heated water is dispensed from high-pressure output line 232. In the preferred embodiment of FIG. 3, high-pressure output line 232 is proximate to and joined to low-pressure output line 230 at some point before spout 202. This allows spout 202 to serve as the dispensing ends of both low-pressure output line 230 and high-pressure output line 232. Spout 202 serves to dispense heated water at either low pressure or high pressure.

By affixing high-pressure output line 232 proximate low-pressure output line 230, pressure-control device 222 may readily be realized as a valve (FIG. 3) within low-pressure output line 230, or as a fitting (FIG. 4) that slides or clips onto the end of spout 202.

When realized as a fitting, pressure-control device 222 must occlude low-pressure output line 230 and must not occlude high-pressure line 232 when affixed to the end of spout 202. This may be accomplished through the shape of pressure-control device 222, which may have a cutaway, notch, or hole that aligns with the end of high-pressure output line 232 and allows high-pressure output line 232 to remain unoccluded.

In the preferred embodiment of FIG. 4, high-pressure output line 232 enters and becomes encompassed by low-pressure output line 230 at some point before spout 202. Again, this allows spout 202 to be the ends of both low-pressure output line 230 and high-pressure output line 232. Spout 202 serves to dispense heated water at either low or high pressure. By encompassing high-pressure output line 232 within low-pressure output line 230, pressure-control device 222 may readily be realized as a valve (FIG. 3) within low-pressure output line 230, or as a fitting (FIG. 4) that slides, clips, bayonets, or screws onto the end of spout 202.

Desirably, low-pressure output line 230 and high-pressure output line 232 are concentric, as concentricity makes attachment of a bayonet or screw-on pressure-control device 222 more readily realizable. Pressure-control device 222 may have a concentric hole that aligns with the end of high-pressure output line 232 and allows high-pressure output line 232 to remain unoccluded. Those skilled in the art will appreciate, that concentricity, while desirable, is not a requirement of the present invention.

In the preferred embodiment of FIG. 5, high-pressure output line 232 does not couple to low-pressure output line 230. Rather, low-pressure output line 230 terminates alone at spout 202 (low-pressure spout 202 in this embodiment) and high-pressure output line 232 terminates at an independent high-pressure spout 216. Pressure-control device 222 may readily be realized as a valve (FIG. 3) within low-pressure output line 230, or as a disk or fitting (FIG. 4) that slides, clips, or screws onto the end of low-pressure spout 202. When realized as a disk or fitting, pressure-control device 222 may attach to low-pressure spout 202 without interfering with high-pressure output line 232. High-pressure spout 216 may be a part of faucet 204 (not shown), or may remain independent (shown).

Those skilled in the art will appreciate that when pressure-control device 222 is realized as a disk or fitting (FIG. 4), then any method of attaching and/or detaching pressure-control device 222 to/from spout 202 known to those skilled in the art may be used without departing from the spirit of the present invention.

Those skilled in the art will appreciate that the manner in which low-pressure line 230 and high-pressure output line 232 are terminated, the number and type of spouts 202 and 216 incorporated, and the structure of faucet 204 are not germane to the present invention. Arrangements other than those discussed and/or depicted herein may be used without departing from the spirit of the present invention.

In a typical installation (not shown), faucet 204 is mounted to the edge of a sink (or to a countertop proximate the edge of a sink) so that spout 202 (spouts 202 and 216) overhang the basin of the sink. By mounting spout 202 (spouts 202 and 216) overhanging the basin, a beverage receptacle 234 may easily be placed or held within the basin for filling. Additionally, any spillage will be directed into the basin, facilitating easy cleaning and maintaining sanitary conditions.

Supply line 224, input line 228, water heater 208, low-pressure output line 230, NO solenoid valve 210, pressure sensor 218, NC solenoid valve 212, pump 214, high-pressure output line 232, timer 220, and all connections (including electrical connections) are mounted below the countertop (typically under the sink), and are therefore out of the way and out of sight.

When realized as a valve, pressure-control device 222, may be a part of faucet 204. Alternatively, pressure-control device 222 may be mounted proximate to faucet 204.

When realized as an attachment to spout 202, i.e., as a disk or fitting, pressure-control device 222 is physically removed from spout 202 when in its open state and attached to spout 202 when in its closed state. When in its open state, pressure-control device may be stored in a convenient place proximate spout 202 so as to be available for attachment to spout 202.

Those skilled in the art will appreciate the fact that pressure-control device 222, when realized as an attachment to spout 202, is not physically attached to the rest of system 200 when pressure-control device 222 is. This lack of attachment is the mechanism by which pressure-control device is rendered into its open state, and may not be construed to imply that pressure-control device 222 is not a part of system 200 at all times.

FIG. 6 depicts a schematic view of system 200 dispensing low-pressure heated water 236 in accordance with a preferred embodiment of the present invention. The following discussion refers to FIG. 6.

External water supply 226 is typically a public or private domestic water supply. As such, external water supply 226 has an inherent water pressure. This pressure, being the lowest static water pressure used within system 200, constitutes the low pressure.

When faucet valve 206 is in its closed state (FIG. 3), external water supply 226 is inhibited from passing unheated water 238 into system 200, and system 200 is inhibited from dispensing heated water at any pressure.

When faucet valve 206 is in its open state position (FIG. 4), the low pressure forces unheated water 238 to flow from external water supply 226, through supply line 224, through faucet valve 206, through input line 228, and into water heater 208. Water heater 208 then heats unheated water 238 and produces low-pressure heated water 236. Desirably, low-pressure heated water 236 is near-boiling water, i.e., water hotter than 176° F. (80° C.).

The low pressure from external water supply 226 then forces low-pressure heated water 236 to flow from water heater 208 into low-pressure output line 230.

In order for system 200 to dispense low-pressure heated water 236, pressure-control device 222 must be in its open state, i.e., low-pressure output line 230 must be unoccluded.

When pressure-control device 222 is in its open state, the low pressure forces low-pressure heated water 236 to flow through low-pressure output line 230 (i.e., through NO solenoid valve 210 in its open state, past pressure sensor 218, and through pressure-control device 222) and out of spout 202.

Under generally accepted principals of physics well known to those of ordinary skill in the art, a moving fluid has less pressure than the same fluid static. Therefore, since low-pressure heated water 236 is flowing through low-pressure output line 230, the pressure of low-pressure heated water 236 at any point in low-pressure output line 230, including at pressure sensor 218, must be less than the low pressure. Pressure sensor 218 senses that the pressure of low-pressure heated water 236 is less than the low pressure, and system 200 takes no further action. System 200 therefore dispenses low-pressure heated water 236.

When dispensing system 200 low-pressure heated water 236, preferably into beverage receptacle 234 (e.g., a cup), low-pressure heated water 236 may mix with a beverage essence (not shown) to produce the desired beverage. System 200 serves well for beverages such as instant coffee, instant cocoa, instant soup, bouillon, tea, and the like. These “instant” and/or steeped beverages are made by mixing the beverage essence with or steeping the beverage essence in heated water. Pressure is not involved in the production of the beverage.

System 200 ceases to dispense low-pressure heated water 236 when faucet valve 206 is returned to its closed state.

FIGS. 7 and 8 depict schematic views of system 200 determining pressure prior to dispensing high-pressure heated water 240 (FIG. 7) and while dispensing high-pressure heated water 240 (FIG. 8) in accordance with a preferred embodiment of the present invention. The following discussion refers to FIG. 7.

As discussed hereinbefore in conjunction with the dispensing of low-pressure heated water 236, when faucet valve 206 is in its open state (FIG. 4), the low pressure forces unheated water 238 to flow from external water supply 226, through supply line 224, through faucet valve 206, through input line 228, and into water heater 208. Water heater 208 then heats unheated water 238 and produces low-pressure heated water 236. Continuing action of the low pressure then forces low-pressure heated water 236 to flow from water heater 208 into low-pressure output line 230.

In order for system 200 to dispense high-pressure heated water 240, pressure-control device 222 must be in its closed state, i.e., low-pressure output line 230 must be occluded.

Whe low-pressure output line 230 is occluded, the low pressure forces low-pressure heated water 236 to flow into low-pressure output line 230 (i.e., through NO solenoid valve 210 in its open state, and past pressure sensor 218) up to pressure-control device 222. Low-pressure heated water 236 then assumes a substantially static condition within low-pressure output line 230.

Under generally accepted principals of physics well known to those of ordinary skill in the art, a moving fluid has less pressure than the same fluid static. Since low-pressure heated water 236 is substantially static within low-pressure output line 230, the pressure of low-pressure heated water 236 at any point in low-pressure output line 230, including at pressure sensor 218, is substantially the low pressure. Pressure sensor 218 senses that the pressure of low-pressure heated water 236 is substantially at the low pressure.

In the preferred embodiments, pressure sensor 218 is electrically an open switch. When pressure sensor 218 senses the pressure of low-pressure heated water 236 is substantially the low pressure, pressure sensor 218 closes and dispatches a high-pressure signal 242 to timer 220. High-pressure signal 242 causes timer 220 to activate.

The following discussion refers to FIG. 8.

Once activated, timer 220 dispatches a pressure-change signal 244 to NO solenoid valve 210, NC solenoid valve 212, and pump 214. That is, timer 220 causes power to be applied to NO solenoid valve 210, NC solenoid valve 212, and pump 214.

Having been activated, NO solenoid valve 210 changes to its closed state and NC solenoid valve 212 changes to its open state. This disconnects low-pressure output line 230 from pressure-control device 222 (and from pressure sensor 218) and connects low-pressure output line 230 to pump 214.

Pump 214 is also activated, and pumps low-pressure heated water 236 from low-pressure output line 230 to high-pressure output line 232. In so doing, pump 214 increases the pressure of low-pressure heated water 236 to that of high-pressure heated water 240.

Being in its closed state, pressure-control device 222 occludes low-pressure output line 230, but does not occlude high-pressure output line 232. Since high-pressure output line 232 is not occluded, high-pressure heated water 240 flows from the end of high-pressure output line 232 at spout 202 or, in some embodiments, high-pressure spout 216. That is, system 200 dispenses high-pressure heated water 240.

Desirably, high-pressure heated water 240 is dispensed as a high-pressure spray 246 into a beverage-essence filter 248 proximate spout 202 or 216. This allows a beverage essence (not shown) contained within beverage-essence filter 248 to be uniformly mixed with high-pressure heated water 240 and produces a beverage 250, which is then dispensed into beverage receptacle 234. However, this is not a requirement of the present invention. Other manners of dispensing high-pressure heated water 240 may be used without departing from the spirit of the present invention.

Timer 220 desirably maintains activation of NO solenoid valve 210, NC solenoid valve 212, and pump 214 for a time sufficient to dispense enough high-pressure heated water 240 to fill the beverage receptacle 234 most commonly used. If timer 220 times out, then power is removed from NO solenoid valve 210, NC solenoid valve 212, and pump 214. NO solenoid valve 210 reverts to its open state and NC solenoid valve 212 reverts to its closed state. Low-pressure heated water 236 then flows back into occluded low-pressure output line 230 to again become static at the low pressure, pressure sensor 218 again detects the low pressure, timer 220 is again triggered, and so forth. System 200 will therefore repetitively dispense controlled amounts of high-pressure heated water 240. This facilitates the production of beverages in small, medium, and large sizes.

System 200 ceases to dispense high-pressure heated water 240 at any time faucet valve 206 is returned to its closed state, regardless of the status of timer 220.

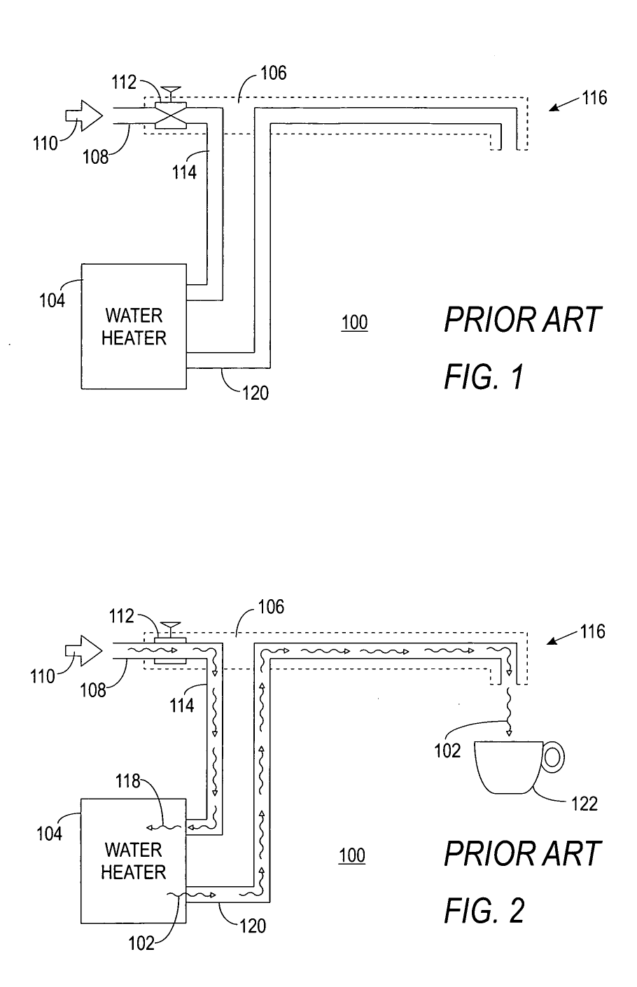

The following discussion refers to FIGS. 1 and 3.

In one embodiment of the present invention, a prior art system 100 may be modified to produce system 200. Prior art system 100, when used as a part of system 200 becomes a low-pressure water heating and dispensing system 300 (FIG. 3). To system 300 may be added a modification kit 350 (FIG. 3), with which system 300 may be modified into dual-pressure water heating and dispensing system 200.

Low-pressure system 300 contains supply line 224 (to be coupled to external water supply 226), faucet valve 206 (as a part of faucet 204), input line 228, water heater 208, low-pressure output line 230, spout 202 (as another part of faucet 204, and an electrical connection (not shown) for water heater 208.

Modification kit 350 contains NO solenoid valve 210, pressure sensor 218, NC solenoid valve 212, pump 214, high-pressure output line 232, high-pressure spout 216 (if used), timer 220, and various electrical connections and line parts (not shown) for timer 220.

To modify low-pressure system 300 with modification kit 350, low-pressure output line 230 is disconnected from water heater 208. NO and NC solenoid valves 210 and 212 are attached to water heater 208. NO solenoid valve 210 is attached to low-pressure output line 230. NC solenoid valve 212 is attached to pump 214. Pump 214 is attached to high-pressure output line 232. High-pressure output line 232 is then coupled to spout 202 as depicted in FIGS. 3 or 4, or to high-pressure spout 216 as depicted in FIG. 5. Pressure sensor 218 is then coupled to low-pressure output line 230, and all electrical connections are made.

By using low-pressure system 300 and modification kit 350 to produce dual-pressure system 200, a savings may be realized over a produced-from-scratch system 200.

Those skilled in the art will appreciate that, while neither discussed herein nor depicted in the Figures, there is nothing in the present invention to prevent the installation of lines and/or valves so that spout 202 (or another spout) may dispenses unheated water 238 on demand. The inclusion of additional lines and fitting to perform this and/or other tasks does not depart from the spirit of the present invention.

In summary, the present invention teaches a system 200 and method to heat and dispense water. System 200 is capable of dispensing either low-pressure heated water 236, suitable for the production of “instant” or steeped beverages, or high-pressure heated water 240, suitable for the production of “pressed” beverages. System 200 is simple in structure, low in cost, and utilizes a minimum of counter space after installation.

Although the preferred embodiments of the invention have been illustrated and described in detail, it will be readily apparent to those skilled in the art that various modifications may be made therein without departing from the spirit of the invention or from the scope of the appended claims.

1. A system to heat and dispense water, said system comprising:
a water heater configured to receive water at a first temperature and at a first pressure, and configured to supply said water at a second temperature greater than said first pressure and at said first pressure;
a pump coupled to said water heater, configured to receive said water at said second temperature and at said first pressure, and configured to supply said water at said second temperature and at a second pressure greater than said first pressure;
a faucet valve coupled to said water heater, and configured to control a flow of said water into said water heater at said first temperature; and
a spout coupled to said water heater and said pump, and configured to dispense said water at said second temperature and at one of said first pressure and said second pressure.

2. A system as claimed in claim 1 wherein:
said faucet valve has an open state and a closed state; and
said system is inhibited from dispensing said water when said faucet valve is in said closed state.

3. A system as claimed in claim 1 wherein:
said faucet valve has an open state and a closed state;
said system additionally comprises a pressure-control device coupled to said water heater, wherein said pressure-control device has an open state and a closed state; and
said system dispenses said water at said second temperature and at said first pressure when said faucet valve is in its open state and said pressure-control device is in its open state.

4. A system as claimed in claim 1 wherein:
said faucet valve has an open state and a closed state;
said system additionally comprises a pressure-control device coupled to said water heater, wherein said pressure-control device has an open state and a closed state; and
said system dispenses said water at said second temperature and at said second pressure when said faucet valve is in its open state and said pressure-control device is in its closed state.

5. A system as claimed in claim 1 wherein:
said faucet valve has an open state and a closed state; and
said system additionally comprises:
a solenoid valve coupled between said water heater and said spout, wherein said first solenoid valve has an open state and a closed state;
a pressure-control device coupled to said first solenoid valve, wherein said pressure-control device has an open state and a closed state; and
a pressure-control device coupled to said first solenoid valve, coupled to said second solenoid valve, and configured to monitor said pressure-control device.

6. A system as claimed in claim 5 wherein:
said solenoid valve is a first solenoid valve;
said system includes a second solenoid valve coupled between said water heater and said pump, wherein said second solenoid valve has an open state and a closed state;
said faucet valve is in its open state;
said first solenoid valve is in its open state;
said second solenoid valve is in its closed state;
said pressure-control device is in its open state; and
said spout dispenses said water at said second-temperature and at said first pressure when said pressure sensor senses said pressure-control device is in its open state.

7. A system as claimed in claim 5 wherein:
said solenoid valve is a first solenoid valve;
said system includes a second solenoid valve coupled between said water heater and said pump, wherein said second solenoid valve has an open state and a closed state;
said faucet valve is in its open state;
said first solenoid valve is in its open state;
said second solenoid valve is in its closed state;
said pressure-control device is in its closed state; and
said first solenoid valve is closed when said pressure sensor senses said pressure-control device is in its closed state;
said second solenoid valve is changed to its open state when said pressure sensor senses said pressure-control device is in its closed state; and
said spout dispenses said water at said second temperature and at said second pressure when said pressure sensor senses said pressure-control device is in its closed state.

8. A system as claimed in claim 1 wherein said second temperature is not less than 80° C.

9. A method to heat and dispense water at one of a first pressure and a second pressure greater than said first pressure, said method comprising:
opening a faucet valve to pass water from a water supply into a water heater at a first temperature and at said first pressure;
heating said water to a second temperature greater than said first temperature;
determining whether said water is to be dispensed at said first pressure or said second pressure; and
dispensing said water at said second temperature and at one of said first pressure and said second pressure in response to said determining activity.

10. A method as claimed in claim 9 wherein:
said determining activity determines whether a pressure-control device is in an open state or a closed state; and
said dispensing activity dispenses said water at said first pressure when said determining activity determines that said pressure-control device is in said open state.

11. A method as claimed in claim 9 wherein:
said determining activity determines whether a pressure-control device is an open state or a closed state; and
said dispensing activity dispenses said water at said second pressure when said determining activity determines that said pressure-control device is in said closed state.

12. A method as claimed in claim 11 wherein said method additionally comprises pumping said water from said first pressure to said second pressure, said second pressure being greater than said first pressure.

13. A method as claimed in claim 9 wherein:
said method additionally comprises:
closing a pressure-control device;
pumping said water from said first pressure to said second pressure; and
said dispensing activity dispenses said water at said second temperature and at said second pressure.

14. A method as claimed in claim 9 wherein:
said determining activity comprises sensing a pressure of said water at a pressure sensor wherein:
when a pressure-control device is in an open state, said pressure at said pressure sensor is less than said first pressure; and
when said pressure-control device is in a closed state, said pressure at said pressure sensor is substantially said first pressure; and
said dispensing activity dispenses said water in response to said sensing activity, wherein:
said dispensing activity dispenses said water at said first pressure when said sensing activity senses said pressure is less than said first pressure; and
said dispensing activity dispenses said water at said second pressure when said sensing activity senses said pressure is substantially said first pressure.

15. A system to heat and dispense water at one of a first pressure and a second pressure greater than said first pressure, said system comprising:
a faucet valve configured to control the passage of water from a water supply at a first temperature and at said first pressure, wherein said first temperature and said first pressure are substantially a temperature and a pressure of said water within said water supply;
a water heater configured to heat said water to a second temperature greater than said first temperature;
a pump coupled to said water heater and configured to pump said water to a second pressure greater than said first pressure;
a spout coupled to one of said water heater and said pump, and configured to dispense said water at said second temperature and at one of said first pressure and said second pressure; and
a pressure-control device having an open state and a closed state, wherein:
when said pressure-control device is in said open state, said system is configured to dispense said water at said first pressure; and
when said pressure-control device is in said closed state, said system is configured to dispense said water at said second pressure.

16. A system as claimed in claim 15 additionally comprising:
a pressure sensor configured to sense a pressure of said water at said second temperature, wherein:
when said pressure-control device is in said open state, said pressure at said pressure sensor is less than said first pressure; and
when said pressure-control device is in said closed state, said pressure at said pressure sensor is substantially said first pressure;
a first solenoid valve coupled between said water heater and said pressure sensor, wherein:
said first solenoid valve has an open state an a closed state;
said first solenoid valve is in its open state when said pressure at said pressure sensor is less than said first pressure; and
said first solenoid valve is in its closed state when said pressure at said pressure sensor is substantially said first pressure; and
a second solenoid valve coupled between said water heater and said pump, wherein:
said second solenoid valve has an open state an a closed state;
said second solenoid valve is in its closed state when said pressure at said pressure sensor is less than said first pressure; and
said second solenoid valve is in its open state when said pressure at said pressure sensor is substantially said first pressure.

17. A method to heat and dispense water at one of a first pressure and a second pressure greater than said first pressure, said method comprising:
configuring the dispensation of said water at one of said first pressure and said second pressure;
passing said water into a water heater at a first temperature and at said first pressure;
heating said water to a second temperature greater than said first temperature;
passing said water from said water heater to a spout through a first solenoid valve;
sensing a pressure of said water at a pressure sensor, wherein:
when said configuring activity has configured said system to dispense said water at said first pressure, said pressure at said pressure sensor is less than said first pressure; and
when said configuring activity has configured said system to dispense said water at said second pressure, said pressure at said pressure sensor is substantially said first pressure;
passing, when said sensing activity senses said pressure at said pressure sensor is substantially said lower pressure, said water from said water heater to a pump through a second solenoid valve;
pumping said water to a second pressure greater than said first pressure;
passing said water from said pump to said spout; and
dispensing said water from said spout at said second temperature and at one of said first pressure and said second pressure, wherein:
said dispensing activity dispenses said water at said first pressure when said sensing activity senses said pressure at said pressure sensor is less than said lower pressure; and
said dispensing activity dispenses said water at said second pressure when said sensing activity senses said pressure at said pressure sensor is substantially said first pressure.

18. A method as claimed in claim 17 wherein, when said configuring activity configures the dispensation of said water at said first pressure, said method additionally comprises setting a pressure-control device to an open state.

19. A method as claimed in claim 17 wherein, when said configuring activity configures the dispensation of said water at said second pressure, said method additionally comprises setting a pressure-control device to a closed state.

20. A dual-pressure system to heat and dispense water, said dual-pressure system comprising:
a single-pressure system to heat and dispense water, said single-pressure system comprising:
a faucet valve configured to control the passage of water at a first temperature and at a first pressure;
an input line coupled to said faucet valve and configured to pass said water at said first temperature and at said first pressure;
a water heater coupled to said input line and configured to heat said water to a second temperature greater than said first temperature;
a first output line coupled to said water heater and configured to pass said water at said second temperature and at said first pressure; and
a spout coupled to said first output line and configured to dispense said water at said second temperature and at said first pressure; and
a kit configured to modify said single-pressure system to produce said dual-pressure system, said kit comprising:
a pump coupled to said first output line and configured to pump said water to a second pressure greater than said first pressure;
a second output line coupled between said pump and said spout and configured to pass said water at said second temperature and at said second pressure, wherein said spout is now configured to dispensed said water at said second temperature and at one of said first pressure and said second pressure;
a pressure-control device coupled to said first output line, wherein:
said pressure-control device has an open state and a closed state;
when said pressure-control device is set to its open state, said dual-pressure system is configured to dispense said water at said first pressure; and
when said pressure-control device is set to its closed state, said dual pressure system is configured to dispense said water at said second pressure;
a pressure sensor coupled to said first output line and configured to sense a pressure of said water within said first output line, wherein:
when said pressure-control device is set to said open state, said pressure at said pressure sensor is less than said first pressure; and
when said pressure-control device is set to said closed state, said pressure at said pressure sensor is substantially said first pressure;
a first solenoid valve coupled into said first output line between said water heater and said pressure sensor, wherein:
said first solenoid valve has an open state and a closed state;
said first solenoid valve is set to its open state when said pressure at said pressure sensor is less than said first pressure; and
said first solenoid valve is set to its closed state when said pressure at said pressure sensor is substantially said first pressure; and
a second solenoid valve coupled into said first output line between said water heater and said pump, wherein:
said second solenoid valve has an open state and a closed state;
said second solenoid valve is set to its closed state when said pressure at said pressure sensor is less than said first pressure; and
said second solenoid valve is set to its open state when said pressure at said pressure sensor is substantially said first pressure.
